(19) United States
(12) Patent Application Publication
(10) Pub. No.: US 2004/0235560 A1
(43) Pub. Date: Nov. 25, 2004

(54) Method for showing the significance of a bettor's stake

(76) Inventor: Michael T. Rossides, Scottsdale, AZ (US)

Correspondence Address: MICHAEL T. ROSSIDES, 11167 E. MIRASOL CIRCLE, SCOTTSDALE, AZ, 85255, US

(21) Appl. No.: 10/848,753

(22) Filed: May 18, 2004

Related U.S. Application Data
(60) Provisional application No. 60/471,539, filed on May 19, 2003.

(51) Int. Cl. G06F 17/00; G06F 19/00

(52) U.S. Cl. 463/25

(57) ABSTRACT

We disclose a core method and sub-methods for improving the communication value of bets by enabling the evaluation of a bettor's stake in a bet offer or agreement. A bettor enters financial data describing his financial resources into an online computer database system for transacting and/or displaying bets. The online database includes formulas for using the financial data to generate measures of the bettor's stake relative to the bettor's financial resources. Accordingly, when the bettor enters a bet offer into the transaction/display system, the system invokes these formulas and generates and displays measures of the bettor's stake in the bet offer. These measures can be viewed along with the bet. Human entered characterizations of a bettor's stake can also be included within the inventive method.

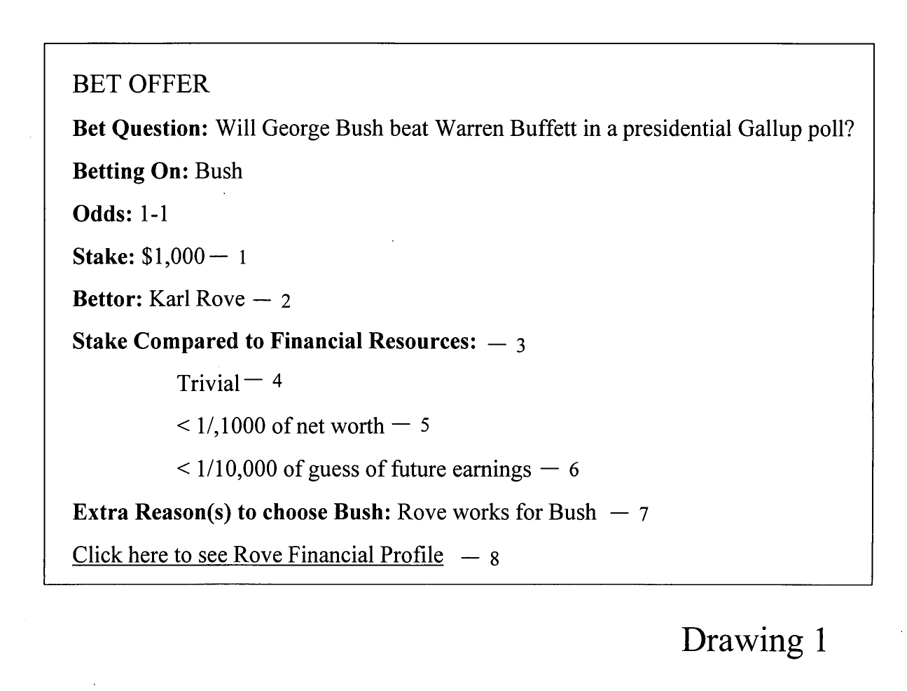

### CROSS-REFERENCES TO RELATED APPLICATIONS

This utility application was preceded by, and claims benefit of, provisional patent application 60/471,539, filed May 19, 2003.

This application refers to U.S. Pat. Nos. 5,575,474 and 6,443,841.

### STATEMENT REGARDING FEDERALLY FUNDED RESEARCH

Not applicable.

### BACKGROUND

1. Field of the Invention

The invention relates to betting methods and media (sometimes called markets) for communicating opinions.

2. Description of Related Art

Methods and systems have been devised for enabling people to express their opinions through bets. U.S. Pat. Nos. 5,575,474 and 6,443,841 disclose methods and systems for using bets to communicate. The Iowa Electronic Markets (http://www.biz.uiowa.edu/iem) enable users to express their opinions on several matters, especially on who is going to win an election. The Hollywood Stock Exchange (www.hsx.com) provides a market system for enabling users to express their opinions on how movies and movie stars will perform. Robin Hanson (http://hanson.gmu.edu/gamble.html) has proposed a betting market to allow people to express scientific opinions.

This application describes a method for enhancing any method or system for using bets to communicate opinions.

The money a bettor risks in a bet is often called the bettor's stake. If a bettor is making a bet offer for the purpose of communicating an opinion, then the size of the stake can be crucially important to whether people consider the bettor to believe his opinion as expressed in his bet offer. For example, if a bettor risks a penny in a bet offer, then his bet opinion carries little weight beyond an ordinary statement because his stake is trivial.

To take another example, imagine two competing coffee companies, Starbucks, a large company with thousands of employees, and Blue Palm Coffee, a small roaster with four employees. Further, imagine that the CEO of Starbucks has a salary of $2 million and a net worth of $200 million, while the CEO of Blue Palm Coffee has a salary of $50,000 and a net worth of $50,000. Further, imagine an even-odds bet on the question:

Which coffee beans will a random taster prefer, Starbucks or Blue Palm? Finally, given this bet question, imagine that the CEO's of Starbucks and Blue Palm make offers to bet $25,000 on their own brands of coffee beans.

In this scenario, most people would agree that the amount of money at stake is trivial for the CEO of Starbucks, but possibly quite significant for the CEO of Blue Palm. Therefore, people who see these bets will often feel, based on the personal risk involved in risking $25,000, that the CEO of Blue Palm really believes the chances are greater than even-money that a random taster will prefer his Blue Palm Coffee, while the CEO of Starbucks isn't saying much with his $25,000.

A real world example is the case of Michael Eisner, CEO of Disney, who purchased $10 million of Disney stock to demonstrate his “belief” in his company. $10 million was minor relative to his net worth of over $300 million. Moreover, the chance that he would lose more than 30% of his stake was low, and balanced by his upside potential. So he really had little personal risk in his bet on this stock, and thus, his bet had little meaning.

Indeed, the amount of money at stake relative to one's personal resources affects the meaning of a bet. Therefore, it can be useful to provide readers of bet opinions with data that measures and shows how a bettor's stake at risk compares to the bettor's resources. The same principle can apply where the bettor is a company or other entity. Thus, showing the significance of a stake can be an important improvement to any method or system for using bets to communicate.

In this application we will disclose methods for showing the significance of a bettor's stake. While methods and systems have been devised for enabling people to express their opinions through bets, the inventor of the inventive methods disclosed here does not know of any other methods that have been disclosed for explicitly and purposefully showing the significance of a bettor's stake along with the bettor's bet offer.

### OBJECT OF THE INVENTION

The object of the invention is to provide a better way to enable readers/viewers of bet opinions to evaluate the significance of a bettor's stake in a bet offer or bet agreement.

### BRIEF SUMMARY OF THE INVENTION

We disclose a core method and sub-methods for improving the communication value of bets by enabling the evaluation of a bettor's stake in a bet offer or agreement. A bettor enters financial data describing his financial resources into an online computer database system for transacting and/or displaying bets. The online database includes formulas for using the financial data to generate measures of the bettor's stake relative to the bettor's financial resources. Accordingly, when the bettor enters a bet offer into the transaction/display system, the system invokes these formulas and generates and displays measures of the bettor's stake in the bet offer. These measures can be viewed along with the bet. Human entered characterizations of a bettor's stake can also be included within the inventive method.

### BRIEF DESCRIPTION OF THE DRAWINGS

Drawing 1 shows measures of the significance of a bettor's stake displayed along with a bet offer.

### DETAILED DESCRIPTION OF THE INVENTION

### Part 1: Creating and Displaying Characterizations of a Bettor's Stake in a Bet

Terminology

For brevity's sake, we will call the inventive method, a method for showing the significance of a stake (MSSS). The MSSS is incorporated into a method or system for transacting and/or displaying bets, which we will call a bet display system (BDS).

The inventive method is a method for enhancing and operating a BDS.

We use the term characterization to mean a natural language statement or a numerical measure that describes—characterizes—the “significance” of a bettor's stake. We will also use the term measure as a synonym for characterization because measure is shorter.

Throughout the specification we disclose steps and actions that the method includes and that the BDS performs. A more formal way of stating these steps and actions is to say, “the invention provides a method for performing the following step or action.” The reader can implicitly add this longer phrasing where appropriate.

When we say that a bettor or user enters data into a BDS, or that the BDS enters data, we mean that the invention provides a method for entering and storing the data in the BDS.

Basic Steps of the Core Method

A BDS is operated according to the inventive method. Most simply the method is a set of three steps:

Step 1. Bettor enters raw financial data about himself into system for displaying bets, and the BDS stores the data in a financial profile.

Step 2. Bettor enters a bet offer, including a stake at risk, and the BDS stores the offer.

Step 3. BDS displays the bet offer along with the bettor's raw financial data, and/or uses the bettor's financial data to generate measures of the significance of the bettor's stake, and displays these measures, along with the bet offer.

In the description below, we disclose different kinds of measures and characterizations that can be generated about the bettor's stake.

We also disclose suitable measures for when the bettor is a company.

It is may be useful to have a human provide a characterization of a bettor's stake instead of, or along with, a machine generated characterization. Steps for enabling human provided characterizations are disclosed as well.

Step 1: Bettor Enters Raw Financial Data about Himself into System for Displaying Bets, and the System Stores the Data in a Financial Profile.

As part of the inventive method, the BDS will include means, such as a web form, for entering financial information that describes a bettor's financial resources. A bettor enters his raw financial data into the BDS, which stores this information in a financial profile of the bettor.

Accordingly, the invention provides a method for entering and storing financial information about a user including:

A statement of salary/wage income

A statement of total income, including income from all sources

A statement of taxable income

A statement of net worth

An estimate of future earnings

A code or other authorization for accessing the bettor's financial records kept by a third party, such as a credit bureau

(All terms regarding financial resources and income, such as net worth and income are somewhat subjective, and the definition and interpretation of these terms will depend upon the particular implementation.)

Additional information could be entered into the BDS, especially the bettor's place of employment and title. This information might be used in conjunction with financial information to characterize the bettor's stake.

(The BDS will also provide steps for enabling a user to modify his financial profile data.)

It is also possible to enable a bettor to have an agent enter the financial data, and for the identity of the agent to be made part of the financial profile. This capability can be especially useful where the agent is a trusted third party.

Step 2: Bettor Enters a Bet Offer, Including a Stake at Risk.

The financial profile that the BDS stores can be used to characterize the stake in any offer that the bettor makes in the BDS.

When the bettor enters a bet offer for display, the BDS can then invoke a process for displaying a characterization of the bettor's stake, as explained in Step 3 below.

Accordingly, the invention provides a method for displaying a characterization of the bettor's stake, upon a request for a display of a bet offer. This characterization can take many forms, as described in Step 3 below.

Step 3: System Displays the Bet Offer Along with the Bettor's Raw Financial Data, and/or Uses the Bettor's Financial Data to Generate Measures of the Significance of the Bettor's Stake, and Displays These Measures Along with the Bet Offer.

The MSSS can incorporate many ways for characterizing and measuring a bettor's stake using the bettor's financial profile.

The MSSS can simply display the profile along with the bettor's bet offer, or provide a link to the profile so that readers of the bet offer can see the profile if they so desire.

The MSSS can include algorithms that generate and display a variety of statistics, comparing the stake to the financial measures in the bettor's profile. The statistics are simple, useful indicators of the significance of a stake. These statistics can include showing the stake as a percentage, or range of percentages, of:

wages/salary

total annual income

taxable income

total compensation over a specified period

an estimate of future earnings

net worth.

Accordingly, the invention provides a method for invoking an algorithm or algorithms for generating a statistic or statistics for measuring the significance of a bettor's stake in a bet offer; these algorithms using the financial data in the user's financial profile, and generating statistics showing the stake as a percentage of the bettor's wages/salary, income, and net worth, among other important measures of a bettor's worth.

If the BDS stores records of other bet offers that the bettor has made, then the BDS can generate statistics that compare the stake in one bet offer to the stakes risked in the other bet offers. For instance, the size of the stake can be compared to the average and median size of stakes in other bets.

Numerical measures can be graphically displayed, of course, for instance, via meters and color codes (such as red for “high personal danger” in a bet). Numerical measures can also be converted into, and displayed as, natural language characterizations, such as “trivial,” “highly significant,” and so forth, according to a predefined scheme that matches terms to numerical measures.

Accordingly, the invention provides a method for converting a statistic of significance into a natural language description and/or into a graphical representation.

When the Bettor is a Company

If the bettor is a company, then the financial profile information that is entered and stored would be different than for an individual. Company the information can include:

Revenues

Profits

Cash reserves

Number of employees

Ad budget

Book value

Market value

Then, stake measures can be generated that are relative to these financial measures, i.e., Stake as a percentage of: Revenue, Profits, Cash Reserves, Ad Budget, Market Value, and so forth.

Accordingly, the invention provides a method for invoking an algorithm or algorithms for generating a statistic or statistics for measuring the significance of a bettor's stake in a bet offer, where the bettor is a company; these algorithms using the financial data in the bettor's financial profile, and generating statistics showing the stake as a percentage of the bettor's revenues, profits, ad budget, book value, and market value among other important measures of a bettor's worth.

If a company is making bets to support statements about its products, then additional financial information that can be entered is:

Revenue for each product being bet about

The ad budget for each product being bet about

A stake in a product/service bet can then be compared to the revenue for that product/service and the ad budget for that product/service. For instance, if a company's entire ad budget is riding on a bet about the company's flagship product, then that fact may be considered significant by readers of a bet offer.

Accordingly, the invention provides a method for invoking an algorithm or algorithms for generating a statistic or statistics for measuring the significance of a bettor's stake in a bet offer, where the bettor is a company; these algorithms using the financial data in the bettor's financial profile, and generating statistics showing the stake as a percentage of the ad budget for the specific product or service being bet about.

The MSSS can also includes steps and algorithms for calculating and displaying statistics that compare a stake in one bet offer to stakes in other bet offers by the company.

Steps for Enabling People to Enter Comments about a Stake

So far, we have described how the MSSS can include algorithms for that use bettor supplied financial information to provide characterizations of a bettor's stake.

It is also possible for the MSSS to include steps for enabling people to enter characterizations—comments about—a stake. This principle applies whether the bettor is an individual or an entity (e.g., a company). The MSSS can enable:

(a) the bettor himself (or a representative) to enter comments

(b) other users of the BDS to enter comments

(c) a paid third party to enter comments.

Let us discuss these possibilities one at a time.

It may be useful for a bettor to supply his own explanation of why his stake at risk in a bet is significant, why it supplies meaning to the bet. For instance, the bettor might explain why he doesn't risk a larger stake. Thus, the MSSS can include steps for entering and displaying, along with a bet offer, a comment by a bettor about the stake that he has at risk in a bet offer.

Yet a bettor's commentary may be self-serving and false, so it can be useful to enable other users of the BDS to enter commentaries. Thus, the MSSS can include steps for entering and displaying, along with a bet offer, a comment by any user of a BDS about the stake that a bettor has at risk in a bet offer.

Of course, a user who is not the bettor may be biased against the bettor and provide a misleading comment. So, since both a bettor and any user of the BDS may be biased, it can be useful for the MSSS to enable a system authorized, neutral third-party to enter a comment. This third party provides a personal risk rating or a company risk rating regarding a particular stake in a bet offer, indicating the significance of that stake. The MSSS can also enable a bettor to pay this neutral, third party for doing the rating work.

Accordingly, the invention provides a method for enabling user's to enter a comment about the significance of a bettor's stake in a bet offer. The invention further provides for posting this comment along with the bet offer.

The invention provides for enabling the bettor himself to enter such a comment, and/or for any user of the BDS to enter such a comment, and/or for a paid, third party to enter such a comment.

Illustrations

As shown in the illustration of Drawing 1, the bet question is: Will George Bush beat Warren Buffett in a presidential Gallup poll? The bettor is choosing Bush at 1-1 odds. The stake is $1,000 (1). The bettor is identified as Karl Rove (2). There is a sentence fragment (3) explaining that the data fields below will characterize the stake. The stake is characterized as “trivial” (4) and “<1/1,000” of Rove's net worth” (5) and “<1/10,000 of Rove's estimated future earnings” (6). Further, there is a data field where reasons (7) are given why the bettor may have made his selection beyond simply trying to win money in the bet. All the characterizations in this illustration could have been calculated by the BDS, except the last two (6), (7), which would have to be entered by a person who knows Rove's situation. Rove's financial profile is shown as a link (8), which a viewer could click on to view the raw data that the financial characterizations are based upon.

As another example, imagine an entrepreneur who makes and sells glass sinks and wants to bet that her glass sinks are better than a key competitor, High Tech Glass Sinks. Imagine she offers to bet $10,000 at even odds that a glassmaking expert will find that her sinks are of higher quality. Now assume that she also enters a comment about her stake in which she states that the stake equals 95% of her ad budget. This could be the sole characterization of her stake, and yet it could be a useful addition to her bet offer, indicating her conviction in her glass sinks.

As another example, imagine that Frito Lay, the large potato chip maker, is willing to make bets against smaller chip makers that Lay's Chips will win a blind taste test, but that the bets are limited to one $10,000 bet per company. Now, imagine that a user of the BDS where the Frito bet offers are displayed enters a commentary pointing out that the stakes are infinitesimal compared to Frito's $200+million advertising budget. This kind of characterization could help nullify the impact of any bet Frito makes at those stakes.

Expressing and Risking a Stake in a Novel Way

When a person wants to make a powerful statement with a bet offer, he can risk a sum of money that is large relative to his financial resources. But, if no one knows his financial resources, then his statement will not be as powerful.

To address this problem, we disclosed methods above for characterizing a bettor's stake.

A different approach is to enable a bettor to risk a stake that is expressed as a percentage of his net worth, or salary, or other measure of his financial resources.

For instance, assume a person states, “I offer to bet 10% of my net worth, at 1-1 odds, that Blue Palm Coffee will be preferred to Starbucks Coffee in a blind taste test.”

Given the way the stake is phrased, the bet offer may convince readers of the offer that the bettor really believes that Blue Palm Coffee indeed will be preferred.

So, in addition to the MSSS, we disclose here a method for entering (stating) a stake such that a bettor expresses the stake in terms of a percentage of his financial resources.

If the bet offer is accepted, a third party can audit the bettor's finances and a convert the bettor's expression into normally expressed amount of money, which can then be risked in the bet. For instance, if the bettor pledges to risk 5% of his net worth, and an auditor finds that the bettor has a net worth of $1 million, then the bettor has committed to risking a stake of $50,000.

Thus, most simply the method has the following three steps:

1. Bettor enters bet offer into BDS, in which the stake in the offer is expressed in terms of a percentage of financial resources.

2. If bet offer is accepted, system authorized auditor reviews the bettor's financial resources and enters bettor's stake in terms of a specific amount of money.

3. Bettor commits that amount of money in the bet.

The same method can be applied if the bettor is an entity, such as a company.

(As disclosed in U.S. Pat. Nos. 5,575,474 and 6,443,841, the system can also enable the bettor to retract a bet offer, and the system can display this retraction.)

Accordingly, the invention provides a method for enabling a bettor to enter a bet offer into the BDS in which the stake in the offer is expressed in terms of a percentage of financial resources, and further if the bet offer is accepted, enabling a system authorized auditor to review the bettor's financial resources and enters the bettor's stake in terms of a specific amount of money, and further, enabling the bettor to commit that amount of money in the bet, and further to show whether the bettor has committed that amount of money or not (or has retracted the bet offer entirely).

### Part 2: Risk-Adjusting the Characterizations of a Bettor's Stake

The measures described in Part 1 have a shortcoming: they are not risk-adjusted.

They give an impression of how large a stake is compared to a bettor's financial resources, which can be highly useful in many situations. But, often that information may not be enough to get across the significance of a stake, for it may not be an accurate representation of what the bettor is actually risking.

The concept of risk is confusing because it can refer to the amount that a person can lose, for instance, $1,000.

But it can also refer to the probability of loss, for instance, a 1% chance of losing $1,000.

It can also refer to the expected value in a bet, for instance, a 1% chance of losing $1,000 equates to an expected loss of $10.

So, it often gives a false impression to measure the significance of a stake simply by comparing it to a bettor's financial resources.

What needs to be done, ideally, is to evaluate the expected loss.

Yet, often, that does not work very well in the context of a bet because a bettor, in theory, is trying to make a bet offer where his expected value on the bet is positive.

Still, in many cases it is useful to ask, “What is this bettor really risking? ” That could be seen in the example of the Eisner case given in the BACKGOUND section of this specification. Eisner was not risking very much on an expected basis.

So, it may be useful for the inventive method to include steps for indicating the expected loss or gain that a bettor has in a bet. Unfortunately, the problem with this simple-sounding idea is that any estimate of expected value involves a subjective guess about the probability of gain and loss.

Nevertheless, the inventive method may include steps for describing the stake not only in terms of a bettor's financial resources, but also in terms of what is being risked on an expected value basis. In order to do this, the method and system must include steps for entering or generating a probability upon which to base an expected value calculation. At least three possibilities exist:

1. The bettor may enter a statement of his honest guess of the probability of winning or losing his bet, or an honest statement of his expected value in the bet.

2. The system can calculate a “market average” probability taken from all the bets, or a selection of bets, made on the same bet statement (also called a bet question) by other participants in the market over time.

3. The system may use the current “line” on the bet question, as found in the system, where bet offers are being matched.

4. If the system includes a secondary market for bet offers, the price of the bet offers will indicates the market's evaluation of the expected value of those bets offers, and thus, the prices offered can be used as a proxy for expected value.

The inventive method will, then, include steps for taking a risk estimate (which can be provided in a variety of ways, not limited to the ways described above) and generating an expected gain or loss on the stake, and displaying that expected value. Further, an expected value range can be given, based on a probability range, which may be more useful than a single figure.

Importantly, we note that a bet may not be a probability based bet, as defined in U.S. Pat. No. 6,443,841, but that a subjective probability of winning will still be integral to estimating the expected value of any type of bet. So, the disclosure above applies to any kind of bet, including bets that do not use odds as part of the bet offer terms.

### Part 3: Authenticating a Bettor's Financial Information

To improve the value to viewers of the measure(s) of a bettor's stake, it can be useful to authenticate the information that the measures are based upon—the information a bettor enters about his financial resources. Therefore, the core MSSS can include additional methods for authenticating this base information.

Further, ff an authentication process is included, the MSSS can include steps for displaying whether the base information has been authenticated or not. And if the base information has been authenticated, the MSSS can include steps for showing when the authentication took place, and also provide details on the authentication process.

An authentication process may be automated, as when a database system pulls a person's or a company's credit rating from another database. Thus, a system that implements the method can include automated means for pulling a bettor's financial record from a financial database.

Alternatively, a human authenticator may be required who will perform an authentication audit, which results in an audit report. In other words, a person can audit the bettor's financial data, such as a bettor's tax return, and enter into the system an authentication report to be shown along with any stake measure. The “report” may be a single word or phrase, or an icon, which states that the amount is authenticated or not authenticated.

The MSSS can give a bettor options for an audit, or there may only one audit process.

The MSSS can enable a bettor to request and pay for an audit.

The MSSS can enable spot audits in which a bettor's financial information is randomly audited and in which the bettor can be penalized for false statements.

The MSSS can enable users of the bet transaction system to challenge the measures of a bettor's stake measures and thereby trigger an audit. Users may be in a better position to police other users than an automated system of random, spot checks. For instance, a user might see that the measures of a bettor's stake indicate that the bettor is taking an extreme risk in a bet offer because the bettor purports to be poor. This user might know the bettor and know that the bettor really is rich. And so, the user can “report the bettor,” possibly triggering an audit. This method for invoking an audit can be especially useful because some users of a system will often know about a bettor's financial situation, and whether stake measures are reasonably accurate.

I claim:

1. A method for enhancing and operating a bet display system, said method comprised of the following steps:
entering and storing raw, financial data describing a bettor's financial condition in a financial profile of said bettor,
entering a storing a bet offer made by said bettor, including an amount of money that said bettor has at stake,
upon a request by a user to display said bettor's bet offer, also displaying said profile data along with said offer.

2. A method for enhancing and operating a bet display system, said method comprised of the following steps:
entering and storing raw, financial data describing a bettor's financial condition in a financial profile of said bettor,
entering a storing a bet offer made by said bettor, including an amount of money that said bettor has at stake,
upon a request by a user to display said bettor's bet offer, invoking an algorithm for generating statistics from said financial data, said statistics measuring the significance of said bettor's stake relative to said bettor's net worth.
